(19) United States
(12) Patent Application Publication
(10) Pub. No.: US 2019/0360107 A1
(43) Pub. Date: Nov. 28, 2019

(54) METHOD FOR COATING A SUBSTRATE HAVING A CAVITY STRUCTURE

(71) Applicants: Rolls-Royce Deutschland Ltd & Co KG, Blankenfelde-Mahlow (DE); Forschungszentrum Juelich GmbH, Juelich (DE)

(72) Inventors: Susanne SCHRUEFER, Zossen (DE); Tanja WOBST, Berlin (DE); Robert VASSEN, Herzogenrath (DE); Georg MAUER, Toenisvorst (DE); Ralf LAUFS, Juelich (DE); Karl-Heinz RAUWALD, Juelich (DE)

(21) Appl. No.: 16/402,957

(22) Filed: May 3, 2019

(30) Foreign Application Priority Data
May 23, 2018 (DE) 10 2018 112 353.1

(51) Int. Cl. C23C 28/00; C23C 4/134; C23C 4/137; C23C 4/11; F01D 5/28

(52) U.S. Cl. CPC C23C 28/3455; C23C 4/134; C23C 4/137; C23C 4/11; F01D 5/288; F05D 2220/30; F05D 2300/143; F05D 2230/90; F05D 2230/312; F05D 2230/313; F05D 2300/11; F05D 2300/121; F05D 2300/132; F05D 2240/24

(57) ABSTRACT

A method for coating a substrate having a cavity structure, in particular a cooling structure, inside the substrate, wherein the cavity structure includes openings in the surface of the substrate. At least one bonding layer, in particular a diffusion layer, or at least one metallic layer is applied onto the substrate, in particular onto the surface of the substrate, and subsequently at least one thermal protection layer is applied onto the at least one diffusion layer by using a plasma spray physical vapour deposition (PS-PVD) method, a hollow cathode sputtering method or a suspension plasma spray (SPS) method.

### REFERENCE TO A RELATED APPLICATION

This application claims priority to German Patent Application No. 10 2018 112 353.1 filed on May 23, 2018, the entirety of which is incorporated by reference herein.

### BACKGROUND

The disclosure relates to a method for coating a substrate having a cavity structure.

In many fields of technology, for example in the field of aircraft engines, components are stressed by high temperatures. In most cases, these components are exposed to hot gases, for example combustion gases in furnace firing systems or in combustion chambers of aircraft engines. The thermal resistance of such components is therefore important.

One means of increasing the thermal resistance is coating of a substrate for a component with a thermal barrier coating (TBC). Methods for coating with a thermal barrier coating are, for example, known from the following publications:
EP 3 150 741 A1,
Goral et al., The technology of Plasma Spray Physical Vapour Deposition, Journal of Achievements in Materials and Manufacturing Engineering Vol. 55, No. 2, p. 689 ff,
Goral et al., The PS-PVD method—formation of columnar TBCs on CMSX-4 superalloy, Journal of Achievements in Materials and Manufacturing Engineering Vol. 55, No. 2, p. 907 ff;
Mauer et al. Novel opportunities for thermal spray by PS-PVD, Surface & Coating Technology, Vol. 269 (2015), p. 53 ff,
Mauer et al., Process diagnostic in suspension plasma spraying, Surface & Coating Technology, Vol. 205 (2010), p. 961 ff.

Metallic substrates used to construct such components, sometimes comprise cavity structures, for example cooling channels. Those internal cavity structures are leading to openings on the surface of the substrates. The cavity structures may be formed in the substrate during the production process (for example by additive layer manufacturing (ALM)), or the cavity structures are introduced into a cast substrate, for example by laser drilling, after production of the substrate.

### SUMMARY

The object is to provide efficient methods for coating substrates having an already existing internal cavity structure of the type described.

The object is achieved by a method having features as described herein.

In this case, a substrate having an internal cavity structure, in particular a cooling structure, is coated. The cavity structure in this case comprises openings in the surface of the substrate.

In a first step, at least one bonding layer is applied onto the substrate. In this case, a diffusion layer (i.e. one introduced by a diffusion method), or another metallic layer, may be applied onto the substrate.

The diffusion layer is used inter alia to promote adhesion for the subsequently applied at least one thermal barrier coating.

The at least one thermal barrier coating is applied onto the at least one diffusion layer by using a plasma spray physical vapour deposition (PS-PVD) method, a hollow cathode sputtering method or a suspension plasma spray (SPS) method. The PS-PVD method is not a “line-of-sight” coating method, and so it is possible to deposit less material in the region of the openings.

All three methods are highly suitable for not blocking the openings of the already existing internal cavity structure during the coating process, or for blocking them only little. This is due to the fact, inter alia, that the fine particles in the gas flows present in the method are so small that they are entrained by the gas flow. Keeping the openings free of coating saves costs for expensive subsequent processing as laser drilling.

In one embodiment, the SPS method comprises a gas flow with a flow component parallel to the surface of the substrate, i.e. the principal flow direction of the gas flow is not directed perpendicularly onto the substrate. In one particular embodiment, the principal flow direction of the gas flow has an angle α with respect to the surface of the substrate which is less than 30°, in particular less than 15°. In one very particular embodiment, the principal flow direction of the gas flow may also be parallel to the surface of the substrate. With a flat or small impact angle, or even a principal flow direction oriented parallel to the substrate, possible blocking of the openings of the cavity structures is minimized.

In another embodiment, the gas flow is a process gas flow and/or carrier gas flow of the SPS method. An interaction therefore takes place between the gas flow and the substrate by direct deposition from the gas flow onto the surface of the substrate. This reduces the deposition into cavities within the surface.

In this case, it is in particular possible for the particle loaded or particle containing gas flow to be characterized by a Stokes number St<1, in particular St<0.1, more particularly St<0.01, most particularly St<0.001. The dimensionless Stokes number St is a measure of the inertia of a particle for its movement in a moving fluid, in this case a gas. It is the ratio of the characteristic time t_{T}, during which the velocity of the particle comes to match the velocity of the surrounding gas due to friction, to the characteristic time t_{P} in which the gas itself changes its velocity by external influences.

In one embodiment, the at least one diffusion layer is applied by pack aluminizing, a PVD method or an additive layer manufacturing method. All of these methods allow efficient application of the thin diffusion layer.

In one embodiment, the latter may comprise a proportion of MCrAlY, with

M selected from nickel, cobalt, iron, and

Y selected from yttrium, ytterbium, lanthanum or a rare earth,

or may consist of this substance.

It is also possible for the at least one diffusion layer to comprise a proportion of an X aluminide, with

X selected from aluminium, chromium, platinum and/or nickel

or to consist of this substance.

In one embodiment, the at least one thermal barrier coating comprises a proportion of yttrium (for example in the form of Y₂O₃) and/or stabilized zirconium oxide (ZrO₂), or consists of this substance.

In another embodiment, the substrate is metallic and is produced at least partially by an additive layer manufacturing (ALM) method or by a casting method. These methods make it possible to produce complexly shaped components, for example turbine blades.

Since the components are heavily thermally loaded during operation, the substrate comprises a proportion of a high-temperature nickel base alloy, in particular CMSX4, CMSX3, C 263, Mar M 002 and/or C 1023, or consists of such a material.

Furthermore, channels of the cavity structure and/or the openings of the cavity structure may have an average diameter of between 0.5 and 1.5 mm, in particular 1 mm. These dimensions allow efficient use of the cavity structure for cooling purposes.

With at least one of the embodiments of a coating method, a substrate having a cavity structure inside the substrate can be produced, with the cavity structure comprising openings in the surface of the substrate.

A substrate produced in this way may, for example, be used in a combustor tile of a combustion chamber of an aircraft engine, in a turbine blade of an aircraft engine or in a liner for a turbine in an aircraft engine.

### BRIEF DESCRIPTION OF THE DRAWINGS

The solution will be explained in connection with the embodiments represented in the figures, in which:

FIG. 1 shows a schematic partial sectional view of an aircraft engine.

FIG. 2A shows a schematic perspective view of one embodiment of a substrate having an internal cavity structure.

FIG. 2B shows a sectional view of the substrate according to FIG. 2A, with a diffusion layer applied.

FIG. 2C shows a sectional view of the coated substrate according to FIG. 2B, with a thermal barrier coating applied.

FIG. 3A shows a sectional view of a further embodiment of a substrate, having a diffusion layer which is coated with a thermal barrier coating by means of a SPS method, in which a gas flow being guided at an angle to the surface of the substrate.

FIG. 3B shows a sectional view of an embodiment of a substrate, having a diffusion layer which is coated with a thermal barrier coating by means of a SPS method, in which a gas flow being guided parallel to the surface of the substrate.

### DETAILED DESCRIPTION

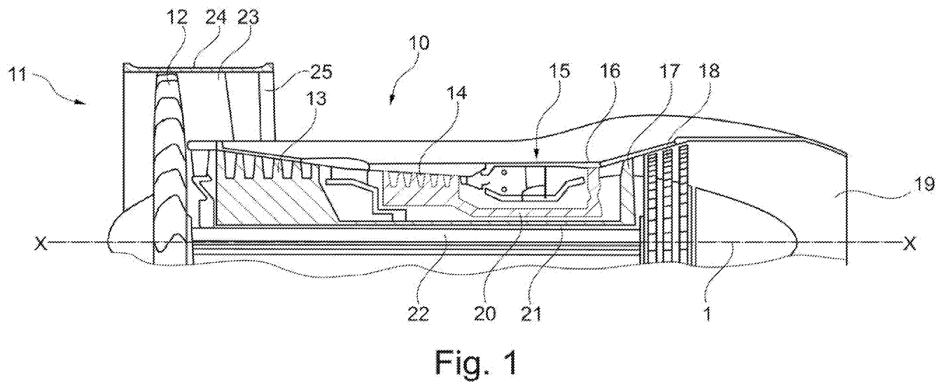

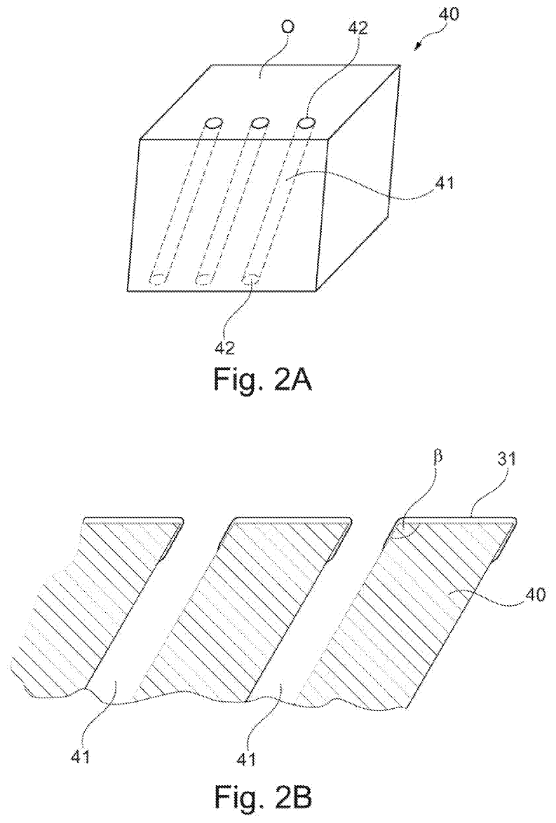

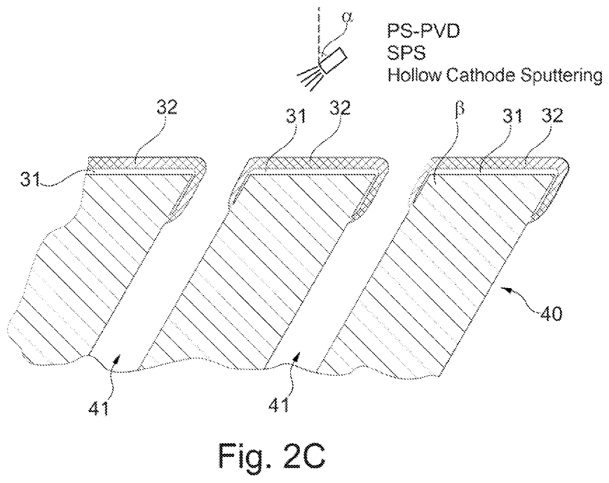

The aircraft engine 10 according to FIG. 1 shows a widely known example of a turbomachine. This is merely one example of a device in which substrates 40 having an internal cavity structure 41 (see FIG. 2) may be used for thermally loaded components. In principle, it is also possible to use such substrates 40 in other devices as well, for example furnace firing systems.

The aircraft engine 10 is usually configured in a manner known per se as a multishaft engine and comprises, successively in the flow direction, an air intake 11, a fan 12 (corresponding to a lowpressure compressor) revolving in a fan case 24, an intermediate pressure compressor 13, a highpressure compressor 14, a combustion chamber 15, a highpressure turbine 16, an intermediate pressure turbine 17 and a lowpressure turbine 18, and also an exhaust gas nozzle 19, all of which are arranged around a central engine axis 1.

The highpressure turbine 16 is configured to drive the highpressure compressor 14 by means of a highpressure shaft 20. The intermediate pressure turbine 17 is configured to drive the intermediate pressure compressor 13 by means of an intermediate pressure shaft 21. The lowpressure turbine 18 is configured to drive the fan 12 by means of a lowpressure shaft 22.

Alternative embodiments of an aircraft engine 10 may also comprise two shafts instead of three shafts.

In one embodiment (not represented here), the shaft of the fan 12 is coupled to a reduction gear unit so that the fan 12 can be operated with a lower rotational speed than the turbine. Thermally loaded components comprising substrates 40 having internal cavity structures 41 are also used in such geared-turbofan engines.

In the embodiment which is represented in FIG. 1, a first part of the air flow which passes through the aircraft engine 10 flows through the intermediate pressure compressor 13 and the highpressure compressor 14, the pressure of the air flow being increased. This air flow is then delivered to the combustion chamber 15 and burnt with injected fuel. The hot gases produced during the combustion flow through the highpressure turbine 16, the intermediate pressure turbine 17 and the lowpressure turbine 18, and thereby drive them. Lastly, the hot gases flow out of the exhaust gas nozzle 19 and thereby generate a part of the thrust of the aircraft engine 10.

A second part of the air flow is fed around the main part of the aircraft engine and flows through a bypass channel 23, which is defined by a fan case 24. This second part of the air leaves the aircraft engine 10 through a fan nozzle 25 while generating a relatively large part of the thrust—compared with the gas emerging from the exhaust gas nozzle 19—of the aircraft engine 10.

FIGS. 2A to 2C schematically represent one embodiment of a method for coating a substrate 40 having an internal cavity structure 41.

FIG. 2A shows an initial situation, i.e. a substrate 40 which comprises an internal cavity structure 41. The representation according to FIG. 2A is represented in a simplified way in several regards for reasons of simplicity. Thus, the substrate 40 is represented for simplicity as a cube, although in principle other substrate shapes, in particular complex shapes, which are for example adapted to the structural conditions in the aircraft engine 10, may also be used. The substrate 40 represented according to FIG. 2A may also be regarded as an excerpt from a larger part.

In the embodiment according to FIG. 2A, the cavity structure 41 inside the substrate 40 is symbolized by three tubular cavities (for example as bores inclined by an angle 13 with respect to the surface O, see FIG. 2B) with openings 42 in two surfaces O of the substrate 40. In principle, it is also possible for a multiplicity of bores to be used as cavity structure 41. The bores also need not all extend in one direction. It is also possible for a complex, amorphous or honeycomb structure to be used as cavity structure 41 inside the substrate 40. Typically, the average diameters of the cavities (in FIG. 1 of the tubular cavities) are in the range of 0.5 to 1.5 mm. The cavity structure 41 may for example be part of a cooling system, through which a coolant can flow. For instance, turbine blades may be configured with an internal cooling system.

The substrate 40 may be produced by an additive layer manufacturing (ALM) method or by a casting method. The cavity structure 41 may, for example, be constructed by laser drilling or during ALM.

In the case of ALM production from a powder bed, the substrate 40 is constructed layer by layer from a nickel base alloy (examples are indicated below) by laser sintering or laser melting. Typical parameters are in this case temperatures in the range of 900 to 1,000° C., pressures in the range of 100 to 110 MPa, and times of up to 2 hours. If it is considered necessary, the substrate 40 may be polished or ground before coating.

The substrate 40 may, however, also be produced by a blown powder ALM method or a cold spray method.

In any case, the substrate 40 already comprises an internal cavity structure 41 before the subsequent coating operations.

In the embodiment represented, the substrate 40 is metallic and is produced at least partially by a layer manufacturing method or by a casting method. In this case, the substrate 40 may comprise a proportion of a high-temperature nickel base alloy, in particular CMSX4, CMSX3, C 263, Mar M 002 or C 1023, or consist of such a material.

A typical composition of CMSX4 from Cannon-Muskegon is (with nickel as remainder):
6.5 wt % Cr,
9.6 wt % Co,
0.6 wt % Mo,
6.4 wt % W,
5.6 wt % Al,
1.0 wt % Ti,
6.5 wt % Ta.
3.0 wt % Re,
0.1 wt % Hf.

A typical composition of CMSX3 from Cannon-Muskegon is (with nickel as remainder):
8.0 wt % Cr,
4.8 wt % Co,
0.6 wt % Mo,
8.0 wt % W,
5.6 wt % Al,
1.0 wt % Ti,
6.3 wt % Ta,
0.1 wt % Hf.

A typical composition of C 263 is (with nickel as remainder):
16 wt % Cr,
15 wt % Co,
3 wt % Mo,
1.25 wt % W,
2.5 wt % Al,
5.0 wt % Ti,
0.025 wt % C,
0.018 wt % B.

A typical composition of Mar M 002 from Cannon-Muskegon is (with nickel as remainder):
8.0 wt % Cr,
10 wt % Co,
10 wt % W,
5.5 wt % Al,
1.5 wt % Ti,
2.6 wt % Ta,
1.5 wt % Hf,
0.15 wt % C,
0.015 wt % B,
0.03 wt % Zr.

A typical composition of C 1023 is (with nickel as remainder):
4.2 wt % Al,
0.16 wt % C,
10 wt % Co,
15.5 wt % Cr,
8.5 wt % Mo,
3.6 wt % Ti,
0.006 wt % B.

It should be noted that these compositions are indicated here without tolerance indications, which are well-known to the person skilled in the art.

In a first step, a diffusion layer 31 is applied onto the substrate 40, as is represented in the sectional view of FIG. 2B.

In the embodiment represented, the application of an aluminide layer as diffusion layer 31 is carried out by pack aluminizing, which is known per se, since this method is economically advantageous.

To this end, the substrate 41 together with a powder containing aluminium is cyclically heated to temperatures in the range of 800 to 1,000° C. Pack aluminizing typically lasts several hours, and a post-heat treatment may subsequently be carried out so that diffusion can take place into the substrate 41.

In the embodiment represented, a single diffusion layer 31 is applied, although this may in principle also comprise a layer sequence.

One possible embodiment of the diffusion layer 31 may comprise a proportion of an X aluminide, with X selected from aluminium, chromium, platinum and/or nickel, or consist of these substances. In particular, a pure aluminide layer or a layer having two or more constituents may therefore also be applied.

The at least one diffusion layer 31 may also comprise a proportion of MCrAlY, with M selected from nickel, cobalt, iron and Y selected from yttrium, ytterbium, lanthanum or a rare earth, or consist of this substance. Such a layer may be applied by means of an ALM method (blown powder) or a PVD method.

The diffusion layer 31 (for example with a thickness in the range of 10 to 90 μm) allows sufficient adhesion, provides oxidation protection and sufficiently prepared surfaces for subsequent coating with a thermal barrier coating 32.

After the application of the diffusion layer 31, a thermal barrier coating 32 is applied onto the at least one diffusion layer 31 by using a plasma spray PVD (PS-PVD) method or a suspension plasma spray (SPS) method (spray angle α). This is represented in FIG. 2C.

It can be seen there that blocking of the openings O is relatively low.

The two methods do not close the openings 42 of the cavity structure 41 during the deposition of the thermal barrier coating 32, or close them only to a small extent, so that for example no subsequent processing or subsequent machining of the openings 42 by means of laser drilling is necessary after the coating. Reprocessing or subsequent machining of the openings 42, in particular with a laser, leads to thermal stresses and therefore weakening of the thermal barrier coating 32 during production.

In the case of PS-PVD, the majority of the powder injected is converted into the vapour phase, the effect of which is that the openings 42 in the substrate clog to a lesser degree.

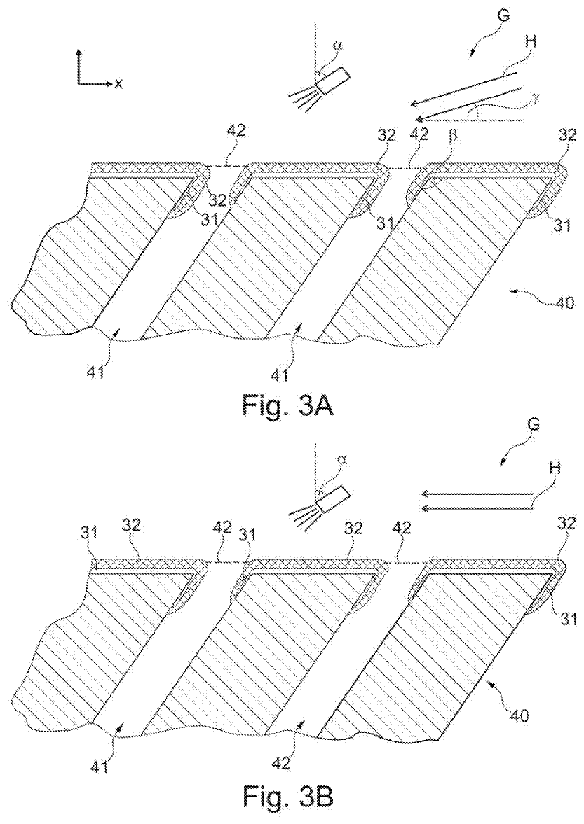

In the case of the SPS method, the coating is deposited from a gas flow (see FIG. 3) which may be inclined or oriented parallel relative to the surface O of the substrate 40 (see FIGS. 3A, 3B). This can reduce or prevent the deposition of coating material in openings 42.

A typical thermal barrier coating 32 is composed of 1 to 3 individual layers which are about 0.1 mm to 0.3 mm thick.

The thermal barrier coating 32 reflects incident hot-gas radiation, forms a thermal insulation layer between the hot gas and the substrate 40, and forms a protective layer against hot-gas corrosion (sulphidation). The total thickness of the thermal barrier coating 32 reaches 0.4 to 0.5 mm, and provides a temperature reduction for the underlying metal of the substrate 40 in the range of 40 to 70 K.

Embodiments of the deposition of the thermal barrier coating 32 by means of a SPS method will be described below.

FIG. 3A represents a substrate 40 onto which, as described in connection with FIG. 2B, a diffusion layer 31 has been applied.

If a gas flow G (for example the carrier gas flow) of the SPS method is used with the principal flow direction H not perpendicular to the substrate surface O but at an angle, clogging of the openings 42 of the cavity structure 41 is minimized or prevented. Blocking of the openings 42 of up to 30% could therefore be accepted in one embodiment.

In FIG. 3A, it is represented that the principal flow direction H of the gas flow G impinges on the surface O of the substrate 40 at an angle of γ=30°. It should be noted that the principal flow direction H of the gas flow G need not be equal to the spray angle α.

Therefore in each case the gas flow G has a flow component X parallel to the surface O of the substrate 40. It is also possible to select the angle α to be less than 30° or even less than 15°.

Via a SPS method, coating from the gas phase is possible since the fine particles in the suspension (for example ethanol, water) follow the gas flow G and are deposited directly from the gas flow G. The gas flow G may therefore even be oriented parallel to the surface O of the substrate 40, as is represented in FIG. 3B. In this embodiment, the risk of blocking the openings 42 is the lowest.

### LIST OF REFERENCES

1 engine axis
10 aircraft engine
11 air intake
12 fan
13 intermediate pressure compressor
14 highpressure compressor
15 combustion chamber
16 highpressure turbine
17 intermediate pressure turbine
18 lowpressure turbine
19 exhaust gas nozzle
20 highpressure shaft
21 intermediate pressure shaft
22 lowpressure shaft
23 bypass channel
24 fan case
25 fan nozzle
31 diffusion layer
32 thermal barrier coating
40 substrate
41 cavity structure
42 opening
G gas flow
O surface
X coordinate direction parallel to the surface
α spray angle
β inclination of cavity structure relative to surface
γ angle of gas flow relative to surface

1. A method for coating a substrate having a cavity structure, in particular a cooling structure, inside the substrate, wherein the cavity structure comprises openings in the surface of the substrate, wherein
a) at least one bonding layer, in particular a diffusion layer, or at least one other metallic layer is applied onto the substrate, in particular onto the surface of the substrate, and subsequently
b) at least one thermal barrier coating is applied onto the at least one diffusion layer by using a plasma spray physical vapour deposition (PS-PVD) method, a hollow cathode sputtering method or a suspension plasma spray (SPS) method.

2. The method according to claim 1, wherein the SPS method comprises a gas flow with a flow component parallel to the surface of the substrate.

3. The method according to claim 2, wherein the principal flow direction of the gas flow has an angle α with respect to the surface of the substrate which is less than 30°, in particular less than 15°.

4. The method according to claim 2, wherein the principal flow direction of the gas flow is parallel to the surface of the substrate.

5. The method according to claim 2, wherein the gas flow is at least one of a process gas flow and a carrier gas flow.

6. The method according to claim 2, wherein the particle-laden gas flow has a Stokes number of less than 1, in particular less than 0.1, more particularly less than 0.01, most particularly less than 0.001.

7. The method according to claim 1, wherein the at least one diffusion layer is applied by pack aluminizing, a PVD method or an additive layer manufacturing method.

8. The method according to claim 1, wherein the at least one diffusion layer comprises a proportion of MCrAlY, with
M selected from nickel, cobalt, iron, and
Y selected from yttrium, ytterbium, lanthanum or a rare earth,
or consists of this substance.

9. The method according to claim 1, wherein the at least one diffusion layer comprises a proportion of an X aluminide, with
X selected from aluminium, chromium, platinum and/or nickel
or consists of this substance.

10. The method according to claim 1, wherein the at least one metallic layer is applied onto the at least one diffusion layer by using a plasma spray physical vapour deposition (PS-PVD) method, a hollow cathode sputtering method or a suspension plasma spray (SPS) method.

11. The method according to claim 1, wherein the at least one thermal barrier coating comprises a proportion of yttrium and/or stabilized zirconium oxide, or consists of the substance.

12. The method according to claim 1, wherein the substrate is metallic and is produced at least partially by a layer manufacturing (ALM) method or by a casting method.

13. The method according to claim 1, wherein the substance comprises a proportion of a high-temperature nickel base alloy, in particular CMSX4, CMSX3, C 263, Mar M 002 and/or C 1023, or consists of such a material.

14. The method according to claim 1, wherein channels of the cavity structure and/or the openings of the cavity structure have an average diameter of between 0.5 and 1.5 mm, in particular 1 mm.

15. A substrate having a cavity structure inside the substrate, wherein the cavity structure comprises openings in the surface of the substrate, producible by a method according to claim 1.

16. A method for using a substrate according to claim 15 in a combustor tile of a combustion chamber of an aircraft engine, in a turbine blade of an aircraft engine or in a liner for a turbine in an aircraft engine.
